(19) United States
(12) Patent Application Publication
(10) Pub. No.: US 2013/0157300 A1
(43) Pub. Date: Jun. 20, 2013

(54) METHODS OF QUANTIFYING EXOSOME IN CELL CULTURE AND METHOD OF INCREASING RECOVERY RATE OF EXOSOME USING THE SAME

(71) Applicant: SAMSUNG ELECTRONICS CO., LTD., Suwon-si (KR)

(72) Inventors: Dong-hyun PARK, Chuncheon-si (KR); Hyun-ju KANG, Hwaseong-si (KR); Myo-yong LEE, Suwon-si (KR)

(73) Assignee: SAMSUNG ELECTRONICS CO., LTD., Suwon-si (KR)

(21) Appl. No.: 13/678,357

(22) Filed: Nov. 15, 2012

(30) Foreign Application Priority Data
Dec. 15, 2011 (KR) 10-2011-0135777

(51) Int. Cl. G01N 21/64

(52) U.S. Cl. CPC G01N 21/6486
USPC 435/23; 435/317.1

(57) ABSTRACT

A method of detecting and recovering of exosomes in a sample, as well as a method of determining the recovery rate of exosomal recovery, and a method of screening for a material that induces secretion of the exosomes in a sample, which methods employ the use of a protease.

### CROSS-REFERENCE TO RELATED APPLICATIONS

This application claims the benefit of Korean Patent Application No. 10-2011-0135777, filed on Dec. 15, 2011, in the Korean Intellectual Property Office, the disclosure of which is incorporated herein in its entirety by reference.

### INCORPORATION-BY-REFERENCE OF MATERIAL SUBMITTED ELECTRONICALLY

Incorporated by reference in its entirety herein is a computer-readable nucleotide/amino acid sequence listing submitted concurrently herewith and identified as follows: One 9,880 Byte ASCII (Text) file named “710590_ST25.txt,” created on Nov. 15, 2012.

### BACKGROUND

Exosomes are membrane-structured vesicles secreted by a wide range of cell types and are to be about 30 nm to about 100 nm in diameter. Studies using scanning electron microscopy (SEM) revealed that exosomes are not directly separated from plasma membranes; rather exosomes are produced from specific intracellular regions called multivesicular bodies (MVBs) and are released and secreted to the extracellular medium. In other words, vesicles that are released to the extracellular environment upon fusion of MVBs and plasma membranes are called exosomes. Although a molecular mechanism involved in the production of exosomes has not been clearly found, a wide range of cell types, including red blood cells, immune cells, such as B-lymphocytes, T-lymphocytes, dendritic cells (DCs), blood platelets, macrophage, and tumor cells, are found to produce and secrete exosomes while alive. Exosomes are known to be released from various different cell types both in normal and pathological conditions.

Exosomes are also known to include immunologically significant major histocompatibility complex (MHC) and heat shock proteins (HSP). Recent studies suggest the use of exosomes as a vaccine composition, which exosomes include MHC class II proteins incorporated therein. The exosomes were obtained from a cell culture after injection of genes able to induce expression of the MHC class II proteins into cancer cell lines. However, in order to effectively produce exosomes from a cell, further research on substances involved in exosome secretion is necessary.

KR 10-2010-0127768A discloses the presence of various types of exosomal microRNAs and a disease diagnostic method based on the presence or absence of the exosomal microRNAs. WO2009-015357A discloses a method of predicting association with a particular disease based on exosomal microRNA variations in a cancer-patient sample (such as blood, saliva, or tear drops). Association of a particular exosomal microRNA with the lung disease also has been disclosed, and diagnostic methods for kidney diseases using exosomal proteins are currently being researched.

For accurate exosome-based diagnosis, accurate quantification of exosomes in a patient is very crucial. Measurement of a quantitative difference between experimentally recovered exosomes and actual exosomes present in a sample is important for accurate exosomal diagnosis. That is, measurement of exosome recovery rate after isolation of the exosomes is crucial in exosome-based diagnosis. Exosomal quantification methods available in the art include a quantitative method using specific antibody-antigen immunoreaction. This method using antibodies is inapplicable when there are antigens in common between artificially manipulated exosomes and naturally occurring exosomes, and the use of antibodies may complicate the overall quantification.

Therefore, a method of screening a substance that generates exosomes and a method of measuring a quantity of the exosomes in a sample are provided according to an embodiment of the present invention.

### SUMMARY

Provided is a method of detecting exosomes containing a fluorescent material with increased detection efficiency, which method comprises incubating a recombinant exosome including the fluorescent material in a cell culture medium comprising a protease, filtering the culture medium using a filter, and detecting fluorescence of the recombinant exosomes filtered from the medium.

Also provided is a method of screening for a substance that promotes secretion of exosomes. The method comprises contacting a cell that secretes recombinant exosomes comprising a fluorescent material with a candidate material to be screened; incubating or culturing the cell and candidate material in a cell culturing medium comprising a protease, wherein recombinant exosomes are secreted into the culturing medium; filtering the recombinant exosomes form cell culturing medium using a filter to obtain filtered exosomes; and measuring fluorescence of the filtered recombinant exosomes. In a related aspect, the method further comprises comparing the fluorescence of recombinant exosomes filtered from the cell culture medium comprising the candidate material and transformed cell to the fluorescence of recombinant exosomes filtered from cell culture medium comprising the transformed cell without the candidate material; wherein an increase in the fluorescence of the recombinant exosomes filtered from the culture medium comprising the candidate material as compared to the culture medium not containing the candidate material indicates that the candidate material promotes secretion of exosomes.

A method of determining a recovery rate of exosomes is further provided, the method comprising providing adding recombinant exosomes comprising a fluorescent material to a sample comprising other (non-recombinant/non-fluorescent) exosomes; incubating the sample with a protease by adding a protease to the sample before or after adding the recombinant exosomes; filtering the exosomes (including the recombinant and non-recombinant exosomes) from the sample using a filter; quantifying the recombinant exosomes in the filtered exosomes by measuring fluorescence in the filtered exosomes; and determining a recovery rate of the exosomes based on a ratio of a quantity of the recombinant exosomes added to the sample and a quantity of the recombinant exosomes in the total filtered exosomes.

Additionally, a method of recovering exosomes is provided, the method comprising incubating a cell culturing medium comprising the exosomes with a protease; and filtering the cell culturing medium using a filter.

Additional aspects of the foregoing methods, including related methods and compositions, are set forth in the description which follows and will be apparent from the description, or may be learned by practice of the presented embodiments.

### BRIEF DESCRIPTION OF THE DRAWINGS

These and/or other aspects of the disclosure will become apparent and more readily appreciated from the following description of the embodiments, taken in conjunction with the accompanying drawings in which:

FIG. 1 is a schematic illustrating an isolation and purification method of exosomes using a protease.

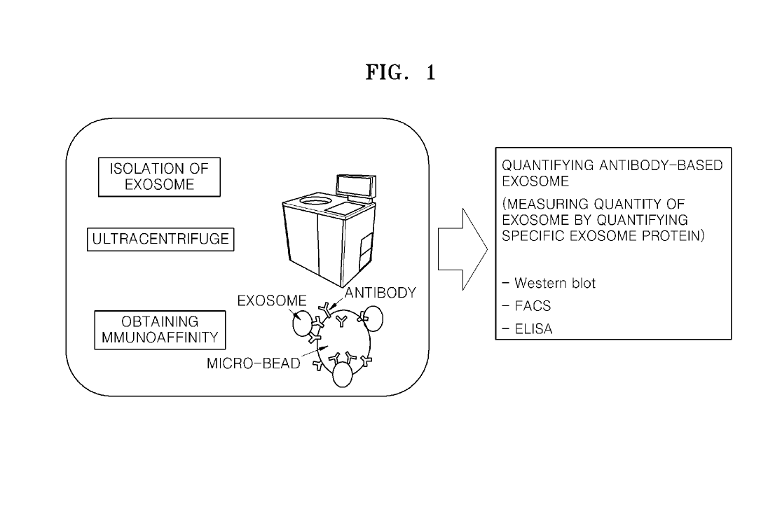

FIG. 2 is a schematic illustrating an exosome purification method using a protease and a filter.

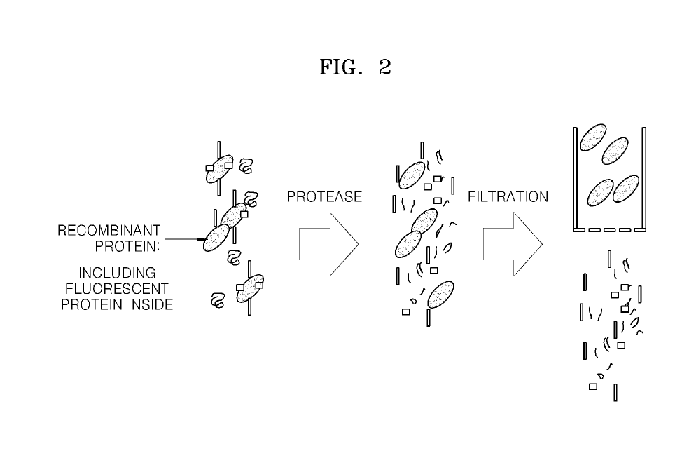

FIG. 3 is a graph of background fluorescence of a recombinant exosome both with (PK+) and without (PK−) protease K. Background fluorescence (x100,000) is indicated on the y-axis and the number of washing cycles is indicated on the x-axis.

FIG. 4 is a graph that illustrates a recovery rate of a green fluorescent protein (GFP) in recombinant exosomes or cell lysate containing CD63-GFP fusion protein. Recovery rate (%) is indicated on the y-axis and the particular sample is indicated on the x-axis.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items.

According to an aspect of the present invention, a method of detecting a recombinant exosome comprising a fluorescent material with increased detection efficiency includes: incubating the recombinant exosome in a cell culturing medium comprising a protease; and filtering the culturing medium using a filter to obtain filtered exosomes, wherein the detection efficiency of the recombinant exosome comprising a fluorescent material is increased by administration of the protease.

The term “fluorescent material” refers to a material that emits light due to a change in physical conditions or a chemical treatment. For example, the fluorescent material may be a fluorescent protein, such as a green fluorescent protein (GFP), a yellow fluorescent protein (YFP), or a red fluorescent protein (RFP), a photoprotein, or a luciferase. Preferably, the fluorescent material is located inside the recombinant exosomes.

For example, the fluorescent material may be exclusively located inside an exosome or may be located inside an exosome in a form of a fusion protein that is combined with a membrane protein. The term “membrane protein” refers to a protein or a glycoprotein inserted to a lipid bilayer of a cell membrane, and includes any protein which penetrates the lipid bilayer or which is located on a surface layer of the cell membrane.

Examples of the membrane protein include, but are not limited to, receptors of enzymes, peptide hormones, local hormones, glucose receptors, ion channels, and cell membrane antigens. The membrane protein also can be an exosomal protein such as, for example, EpCAM, Hsc70, MHC I, Tsg101, calnexin, or gp96. The membrane protein efficiently locates a fluorescent material in an exosome.

The number of molecules of the fluorescent protein included in an exosome may be within a range from 1 to 100 (e.g. 5, 10, 15, 20, 25, 30, 35, 40, 45, 50, 55, 60, 65, 70, 75, 80, 85, 90, or 95), from 2 to 50, or from 5 to 20. The number of molecules of the fluorescent protein located in an exosome may differ according to a type of the fluorescent protein.

The term “protease” refers to an enzyme that breaks a peptide bond by directly operating on a protein. Examples of the protease include, but are not limited to, an endopeptidase, which cleaves the protein from inside, and an exopeptidase, which cleaves an amino acid from an end of the protein. For example, the protease may include pepsin, peptidase, trypsin, protease K, calpain, papain, metalloproteinase, chymotrypsin, elastase, or acetylglutosaminidase, but is not limited thereto. Indeed, the invention includes any protease that can break down a protein. The protease can be used in pH 4-10. The protease can be used in 16° C.-65° C.

Moreover, the method may include incubating the cell culturing medium with glycosidase and/or DNase prior to, or at the same to as, incubation with the protease. The glycosidase is a material that breaks down a sugar (e.g., glucose). For example, the glycosidase may be endoglycosidase or exoglycosidase, more particularly, endoglycosidase F1, endoglycosidase F2, endoglycosidase F3, glucosidase, galactosidase, sucrase, maltase, O-glycosidase, neuraminidase, PNGase, glucosaminidase, or flucosidase.

Although not wishing to be bound by any particular theory, it is believed that the glycosidase enables the protease to break down a protein more efficiently. Thus, when a fluorescent material is measured, background caused by proteins may be effectively removed since most of the proteins are removed.

The DNase refers to a material that breaks down a DNA molecule. The DNase may be exoDNase, which cleaves a phosphodiester bond an end of a phosphonucleotide chain, or endoDNase, which cleaves phosphodiester bonds in the middle of a phosphonucleotide chain.

The sample and the protease, glycosidase and/or DNase can be incubated for any sufficient amount of time that allows the breakdown of the background proteins, sugars, and nucleic acids (e.g., 5 minutes, 10 minutes, 20 minutes, 30 minutes, 1 hour, 2 hours, 3 hours, 4 hours, or more) as discussed herein.

The method also includes filtering the cell culturing medium using a filter. The filter is a membrane that removes various decomposition products that are decomposed by enzymes other than exosomes. The membrane may have pores with a diameter of 100 nm or less (e.g., 90 nm or less, 80 nm or less, 70 nm or less, 60 nm or less, 50 nm or less, 40 nm or less, 30 nm or less, 20 nm or less, or 10 nm or less), 50 nm or less, or 30 nm or less. A material used for the filter is not limited as long as the filter may selectively refine the exosomes by selectively passing particles of a diameter within a range from about 1 nm to about 30 nm (e.g., a filter that passes particles having a diameter of about 30 nm less, to about 1 nm or less).

Various methods may be used to detect the fluorescent material in the exosomes according to the type of the fluorescent material used. For example, when the fluorescent material is a fluorescent protein, the fluorescence when irradiated with ultraviolet light may be measured using a fluorophotometer. When the light-emitting protein is a luciferase, an intensity of light generated by an ATP-luciferase reaction may measured by using a luminometer.

Moreover, a method of measuring fluorescence to quantify exosomes may include a method of measuring a fluorescence intensity for a relative comparison, or a method of measuring exosomes emitting fluorescence while flowing a sample through a nanochannel.

Detection efficiency of the fluorescent material in the exosomes may be increased by following the method according to an embodiment of the present invention. When impurities are present in the cell culturing medium, detection is difficult due to a high level of background fluorescence. Thus, in order to effectively measure a quantity of the fluorescence emitted from the fluorescent material in the exosomes of a cell, a method that removes the impurities present in the cell culturing medium while not breaking down the fluorescent protein that labels the exosomes is necessary. According to the method of an embodiment of the present invention, proteins which are present in the cell culturing medium, and which become a cause of the background fluorescence, may be removed (e.g., by the addition of protease and subsequent filtering), and thus a level of the fluorescent background of the cell culturing medium may be effectively reduced.

Another aspect, the present invention provides a method of screening for a substance that promotes secretion of exosomes. The method comprises contacting a cell that secretes recombinant exosomes including a fluorescent material with a candidate material; incubating the cell and candidate material in a cell culturing medium comprising protease, filtering the cell culturing medium using a filter to obtain filtered exosomes; and measuring fluorescence of the filtered exosomes, wherein an increase in the fluorescence of the filtered exosomes relative to the fluorescence quantified without contact of the cell with a candidate material indicates that the candidate material promotes secretion of exosomes.

The “cell that secretes recombinant exosomes comprising a fluorescent material” refers to a cell from which the exosomes including the fluorescent material are secreted when an expression vector (e.g., a plasmid or a viral vector) including a gene that encodes the fluorescent material is introduced into a cell (i.e., to produce a transformed cell). The cell which is targeted to be transformed may be a cell which is capable of secreting the exosomes. Examples of the cell can include, but are not limited to, MCF7, COS7, 297T, HeLa, and NIH3T3.

The fluorescent material may be located inside an exosome as itself or may be located inside an exosome in a form of a fusion protein that is combined with a membrane protein. The linkage between the fluorescent material and the membrane protein may be possible between a fluorescence protein and an end of an N-terminal or a C-terminal of a membrane protein. However, since the fluorescent protein has to be located inside the exosome, a location of the linkage between the fluorescent protein and the membrane protein may be determined according to a location of a peptide or a protein inside the exosome.

For a transformation method, any method that may introduce a gene into a cell known to one of ordinary skill in the art may be used. For example, a plasmid including a DNA which encodes a fusion fluorescence protein or a virus particle including a DNA which encodes a fusion fluorescence protein may be introduced into a cell, or the DNA which encodes a fusion fluorescence protein may be introduced in a form of a virus RNA.

When the method above is used, the fluorescence emitted from the exosomes including the fluorescent material may be measured with a high sensitivity. Therefore, a quantity of secretion of the exosomes may be confirmed even when the cell secretes the exosomes at a low concentration.

Examples of the candidate material include, but are not limited to, a chemical material, a protein, a lipid, a nucleic acid, or any material that may induce a biochemical reaction in a cell.

In order to confirm the quantity of the exosomes secreted at a certain concentration of the candidate material, the candidate material may be contacted to cells that are transformed at various concentrations.

The screening method may further include incubating the cell culturing medium and glycosidase as discussed herein.

The method may include incubating the cell culturing medium and the protease before or after separating the exosomes. The protease can be any protease, as described herein. Other aspects of the method of screening (e.g., filtering, detecting fluorescence, etc.) are as described with respect to the other methods of the disclosure. Also provided is a method of determining a recovery rate of exosomes comprising providing a sample comprising exosomes (e.g., non-recombinant/non-fluorescent exosomes)

adding recombinant exosomes including a fluorescent material to the sample; adding a protease to the resulting mixture; separating the exosomes using a filter to obtain filtered exosomes; determining a quantity of the filtered exosomes by measuring fluorescence in the filtered exosomes; and determining a recovery rate of the exosomes based on a ratio of a quantity of the recombinant exosomes added to the sample and a quantity of the filtered exosomes.

The sample can be any sample that includes exosomes. According to an embodiment, the sample can be include, but is not limited to, blood, urine, mucus, saliva, teardrops, plasma, serum, sputum, spinal fluid, pleural fluid, nipple aspirate, lymph fluid, respiratory tract fluid, serous fluid, urogenital fluid, breast milk, lymph secretion, sperm, cerebrospinal fluid, secretion in organs, abdominal fluid, fluid from cystic tumor, amniotic fluid, or a combination thereof.

The method may include incubating the sample and the protease for a sufficient amount of time (e.g., 5 minutes, 10 minutes, 20 minutes, 30 minutes, 1 hour, 2 hours, 3 hours, 4 hours, or more) so that the protease can break down the background proteins as discussed herein. Exemplary proteases, glycosidases, and DNases are as described herein with respect to other disclosed methods.

The method may include incubating the sample with glycosidase and/or DNase before incubating with the protease, or at the same time as incubating with the protease. It is believed that the addition of glycosidase enables the protease to decompose the protein more efficiently.

The method includes determining a recovery rate of the filtered exosomes including determining the recovery rate of the exosomes based on a ratio of a quantity of recombinant exosomes obtained after determining the recovery rate of the exosomes based on a ratio of a quantity of the recombinant exosomes added to the sample to a quantity of recombinant exosomes recovered in the filtered exosomes. In other words, the recovery rate of the recombinant exosomes added to the sample can be established by a quantification of the recombinant exosomes added to the sample and quantification of the recombinant exosomes recovered from the sample in the filtered total exosomes. Since the same recovery method is used to recover all exosomes from the sample, the recovery rate of the recombinant exosomes reflects, and may be very close to or identical to, the recovery rate of the total exosomes from the sample. As a result, the recovery rate of the exosomes is used to quantify microRNAs or exosomal proteins included in the exosomes in the sample and thus may be effectively used in exosomes-based diagnosis.

All other aspects of the method of determining a recovery rate are as described with respect to the other methods described herein.

The methods described herein can be used to diagnosis, monitor, or profile cancers using a nucleic acid or a protein included in an exosome. Exemplary cancers include lung cancer, ovarian cancer, uterine cervical cancer, endometrial cancer, breast cancer, brain cancer, colon cancer, prostate cancer, gastrointestinal cancer, head and neck cancer, non-small cell lung cancer, nervous system cancer, kidney cancer, retina cancer, skin cancer, liver cancer, pancreas cancer, urethral cancer, gallbladder cancer, melanoma, or leukemia. Also, the method may be applied to detection, diagnosis, or prediction of a non-malignant tumor such as a neurofibromatosis, a meningioma, or a schwannomas.

A method of recovering exosomes also is provided herein. The method includes incubating a cell culturing medium comprising the exosomes with a protease, and filtering the cell culturing medium using a filter to obtain the exosomes. In preferred aspects, the method of recovering exosomes using a protease results in a recovery rate that is greater than the recovery rate obtained using the same method without a protease.

Without wishing to be bound by any particular theory, it is believed that when decomposition products are removed by using a filter after incubating the cell culturing medium including the exosomes and the protease, proteins other than the exosomes may be effectively removed, and thus the exosomes may be efficiently recovered. Therefore, separating the exosomes using the protease and the filter may be effectively done.

Also, in order to increase activity of the protease, the method may include incubating the cell culturing medium and glycosidase before incubating with the protease or at the same time incubating with the protease as discussed herein. If glucose in the protein is removed by using glycosidase, decomposing efficiency of the protease may be increased.

Moreover, the method may further include separating the exosomes before incubating the cell culturing medium and the protease. The method of separating of the exosomes may be one selected from the group consisting of a density gradient method, ultracentrifugation, filtration, dialysis, an anion exchange method, gel-permeation chromatography, organelle electrophoresis, magnetic-activated cell separation, nanomembrane ultrafiltration concentration, and free-flow electrophoresis, but is not limited thereto.

All other aspects of the method of determining a recovery rate are as described with respect to the other methods described herein.

The present invention will be described in further detail with reference to the following examples. These examples are for illustrative purposes only and are not intended to limit the scope of the invention.

### EXAMPLE 1

### Vector Construction for Fusion Protein Including Membrane Protein and Fluorescent Material

A nucleic acid expressing a fusion protein of CD63-GFP (SEQ ID NO: 1) was inserted into multi-cloning sites (MCS) of the pGL4.76 (AY864931) plasmid template with a cytomegalovirus (CMV) promoter. The resulting plasmid was used to prepare an exosome including the CD63-GFP fusion protein (SEQ ID NO: 2).

### EXAMPLE 2

### Preparation of Recombinant Exosomes

### EXAMPLE 2-1

### Introduction of Gene that Encodes a Fusion Protein Including a Membrane Protein and fluorescent Material-Combined Fusion Protein into a Cell Line

Cells were uniformly inoculated on a 150-mm plate and incubated one day before transfection. 7.5 μg of the plasmid vector was diluted in 7.5 mL of an opti-MEM serum-free medium (available from Invitrogen, Grand Island, N.Y.) and thoroughly mixed, followed by an addition of a Plus reagent (available from Invitrogen), a gentle slow mixing, and incubation at room temperature for about 5 minutes. The incubated mixed solution was further gently mixed, and 187.5 μL of Lipofectamine™ LTX reagent (available from Invitrogen) was directly added thereto, thoroughly mixed together, and incubated at room temperature for about 30 minutes to obtain a DNA-lipid complex.

The resultant was then slowly added dropwise onto a plate containing MCF-7 cells (ATCC, Manassas, Va.) to be transfected, and mixed together by gentle shaking. The plate with the mixed DNA-lipid complex and cells was incubated in a 37° C. CO₂ incubator for about 12-14 hours, followed by an exchange of the fetal bovine serum (FBS)-containing culture medium with a fresh medium containing FBS but free of exosomes. The cells were incubated in a CO₂ incubator at about 37° C. for about 24-48 hours, and the culture medium was collected.

### Example 2-2

### Separation of Recombinant Exosomes from a Cell Culturing Medium Using Centrifugation

50 μL of the culture medium was transferred into a centrifugation tube, which was then centrifuged at about 300×g at about 4° C. for about 10 minutes. After removal of the supernatant using a pipette, the rest of the centrifuged product was transferred into a new centrifugation tube, which was centrifuged again at about 300×g at about 4° C. for about 10 minutes. After removal of the supernatant using a pipette, the rest of the centrifuged product was transferred to a new centrifugation tube, which was centrifuged again at about 2,000×g at about 4° C. for about 20 minutes. The supernatant was transferred into a clean, empty polyallomer tube or polycarbonate bottom durable against ultracentrifugation, which was centrifuged again at about 10,000×g at about 4° C. for about 30 minutes. The supernatant was transferred into an empty ultracentrifugation tube, which was centrifuged again at about 110,000×g at about 4° C. for about 70 minutes, followed by removal of the supernatant using a pipette. The remaining pellet in the centrifugation tube was re-suspended using 1,000 μL of phosphate buffered saline (PBS). After filling the centrifugation tube with PBS, the centrifugation tube was centrifuged at about 100,000×g at about 4° C. for about 70 minutes, followed by removal of the supernatant as completely as possible. Re-suspension of the remaining pellet in the centrifugation tube with PBS was followed by centrifugation at about 100,000×g at about 4° C. for about 70 minutes, and removal of the supernatant was done as completely as possible. The remaining pellet was re-suspended by an addition of a small amount of PBS or tris-buffered saline (TBS). The suspension was stored in about 100 μL aliquots at about −80° C., and thawed immediately before use.

### Example 2-3

### Separation of Recombinant Exosomes from Cell Culturing Medium Using a Filter

The clean culture medium collected in Example 2-1 was moved to a centrifugation tube of 200 μL , and then incubated with a protease K (PK) (available from Sigma-Aldrich, St. Louis, Mo.) in detergent-free buffer.

Then, the culture medium was removed by using a filter (cut-off 100 kd, 4,000 g, 5 minutes). The medium filtered through the filter was discarded, 200 μL of PBS was added again to the unfiltered concentrated solution including the exosome, and the solution was removed by centrifugation (4,000 g, 5 minutes). After repeating 4 cycles of a PBS washing process, the exosomes were quantified using the remaining fluorescence.

### Example 3

### Identification of the Expression of a Fluorescent Material in the Recombinant Exosome

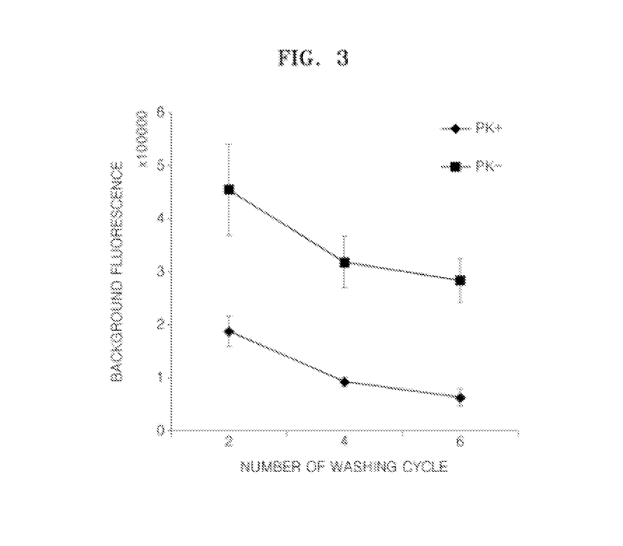

A quantity of the fluorescence was measured using a fluorophotometer (Envision® available from Perkin Elmer, Waltham, Mass.). After radiating light, the quantity of fluorescence of the exosome secreted from the collected recombinant exosome was measured. Here, in the case of the filtered recombinant exosome using a filter after incubating with protease K, a background value was significantly reduced compared to the case of the filtered recombinant exosome without incubating with protease K (see FIG. 3).

### Example 4

### Measurement of Exosome Recovery Rate Using Protease and a Filter

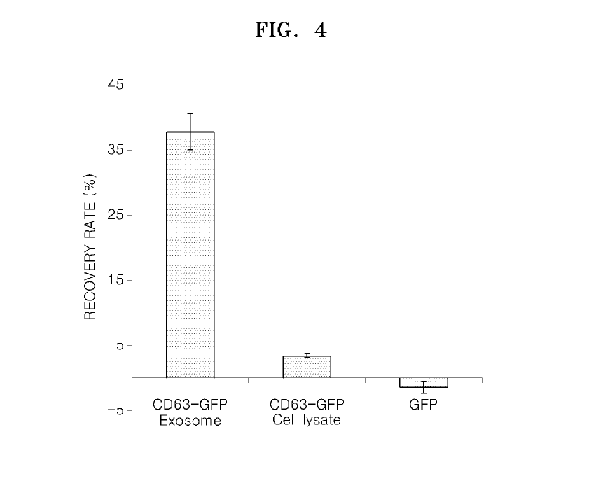

Exosome recovery rates according to a usage of a protease were measured using recombinant exosomes that contained CD63-GFP fusion protein. A vector expressing the fusion protein was transformed in a cell line, and then the exosomes were obtained by using ultracentrifugation in the same manner as described in Example 2-2. The exosomes were then filtered with and without protease as described in Example 2-3(see FIG. 4).

As a result, the amounts of the exosomes in the samples were measured to be different in different recovery conditions even though the samples had the same amount of the actual exosomes. However, the average amounts of the exosomes on which the exosome recovery rates were reflected were similar to the actual amounts of the exosomes added to the samples, and had a reduced coefficient of variation (CV).

TABLE 1

| | | | Filtration after incubation |
|---|---|---|---|
| | Ultracentrifugation | Filtration | with protease |
| CV | 40% | 40% | 15% |

As described above, according to the one or more of the above embodiments of the present invention, a method of effectively measuring a quantity of exosomes in a samples using (i) recombinant exosomes comprising a fluorescent material and (ii) protease and a method of screening a substance that induces secretion of exosomes may be effectively used in exosome-based diagnosis and treatment.

According to the one or more of the above embodiments of the present invention, a quantity of fluorescent released from an exosome may be effectively detected since a background may be significantly reduced by incubating the recombinant exosome and a protease. In this regard, when the background of the fluorescence is reduced, detection sensitivity increases. Thus, even a low concentration of the fluorescence material may be detected. Therefore, a substance enabling secretion of the exosome may be effectively screened by using the same method. Also, the exosome may be more effectively used since an exosome recovery rate may be increased.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of detecting exosomes containing fluorescent material, the method comprising:
incubating recombinant exosomes comprising a fluorescent material in a cell culturing medium comprising a protease;
filtering the culturing medium using a filter;
and;
detecting fluorescence of the recombinant exosomes.

2. The method of claim 1, wherein the method further comprises incubating the recombinant exosomes in a cell culture medium comprising glycosidase.

3. The method of claim 1, wherein the fluorescent material is a fluorescent protein or a photoprotein.

4. The method of claim 1, wherein the protease is pepsin, peptidase, trypsin, protease K, calpain, papain, metalloproteinase, chymotrypsin, or elastase.

5. The method of claim 2, the glycosidase is endoglycosidase F1, endoglycosidase F2, endoglycosidase F3, glucosidase, galactosidase, sucrase, maltase, O-glycosidase, neuraminidase, PNGase, glucosaminidase, or flucosidase.

6. A method of screening for a substance that promotes secretion of exosomes, the method comprising:
contacting a a transformed cell that secretes recombinant exosomes comprising a fluorescent material with a candidate material to be screened; incubating the cell and candidate material in a cell culturing medium comprising a protease, wherein recombinant exosomes are secreted into the cell culturing medium;
filtering the recombinant exosomes from the cell culturing medium using a filter; and
measuring fluorescence of the filtered recombinant exosomes.

7. The method of claim 6 further comprising comparing the fluorescence of recombinant exosomes filtered from the cell culture medium comprising the candidate material and transformed cell to the fluorescence of recombinant exosomes filtered from cell culture medium comprising the transformed cell without the candidate material;
wherein an increase in the fluorescence of the recombinant exosomes filtered from the culture medium comprising the candidate material as compared to the culture medium not containing the candidate material indicates that the candidate material promotes secretion of exosomes.

8. The method of claim 6, wherein the cell culture medium further comprises glycosidase.

9. The method of claim 8, wherein the glycosidase is endoglycosidase F1, endoglycosidase F2, endoglycosidase F3, glucosidase, galactosidase, sucrase, maltase, O-glycosidase, neuraminidase, PNGase, glucosaminidase, or flucosidase.

10. The method of claim 6, wherein the filter passes particles of a diameter less than about 1 nm to about 30 nm.

11. A method of determining the recovery rate of exosomes from a same, the method comprising:
adding recombinant exosomes comprising a fluorescent material to a sample comprising non-recombinant exosomes;
incubating the sample with a protease ;
filtering exosomes from the sample using a filter;
quantifying the recombinant exosomes in the filtered exosomes by measuring fluorescence in the filtered exosomes; and
determining a recovery rate of the exosomes based on a ratio of a quantity of the recombinant exosomes added to the sample and a quantity of the recombinant exosomes in the filtered exosomes.

12. The method of claim 11, wherein the sample is blood, urine, mucus, saliva, teardrops, plasma, serum, sputum, spinal fluid, pleural fluid, nipple aspirate, lymph fluid, respiratory tract fluid, serous fluid, urogenital fluid, beast milk, lymph secretion, sperm, cerebrospinal fluid, secretion in organs, abdominal fluid, fluid from cystic tumor, amniotic fluid, or a combination thereof.

13. A method of recovering exosomes, the method comprising:
incubating a cell culturing medium comprising the exosomes with a protease; and
filtering the cell culturing medium using a filter.

14. The method of claim 13, wherein the method further comprises incubating the cell culturing medium with glycosidase.


SEQUENCE LISTING (2 sequences)

SEQ ID NO: 1 - DNA, 1437 bp, Artificial Sequence
  Synthetic
atggcggtggaaggaggaatgaaatgtgtgaagttcttgctctacgtcctcctgctggccttttgcgcctgtgcagtgggactgattgccgtgggtgtcggggcacagcttgtcctgagtcagaccataatccagggggctacccctggctctctgttgccagtggtcatcatcgcagtgggtgtcttcctcttcctggtggcttttgtgggctgctgcggggcctgcaaggagaactattgtcttatgatcacgtttgccatctttctgtctcttatcatgttggtggaggtggccgcagccattgctggctatgtgtttagagataaggtgatgtcagagtttaataacaacttccggcagcagatggagaattacccgaaaaacaaccacactgcttcgatcctggacaggatgcaggcagattttaagtgctgtggggctgctaactacacagattgggagaaaatcccttccatgtcgaagaaccgagtccccgactcctgctgcattaatgttactgtgggctgtgggattaatttcaacgagaaggcgatccataaggagggctgtgtggagaagattgggggctggctgaggaaaaatgtgctggtggtagctgcagcagcccttggaattgcttttgtcgaggttttgggaattgtctttgcctgctgcctcgtgaagagtatcagaagtggctacgaggtgatgacgcgtacgcggccgctcgagatggagagcgacgagagcggcctgcccgccatggagatcgagtgccgcatcaccggcaccctgaacggcgtggagttcgagctggtgggcggcggagagggcacccccgagcagggccgcatgaccaacaagatgaagagcaccaaaggcgccctgaccttcagcccctacctgctgagccacgtgatgggctacggcttctaccacttcggcacctaccccagcggctacgagaaccccttcctgcacgccatcaacaacggcggctacaccaacacccgcatcgagaagtacgaggacggcggcgtgctgcacgtgagcttcagctaccgctacgaggccggccgcgtgatcggcgacttcaaggtgatgggcaccggcttccccgaggacagcgtgatcttcaccgacaagatcatccgcagcaacgccaccgtggagcacctgcaccccatgggcgataacgatctggatggcagcttcacccgcaccttcagcctgcgcgacggcggctactacagctccgtggtggacagccacatgcacttcaagagcgccatccaccccagcatcctgcagaacgggggccccatgttcgccttccgccgcgtggaggaggatcacagcaacaccgagctgggcatcgtggagtaccagcacgccttcaagaccccggatgcagatgccggtgaagaaagagtt

SEQ ID NO: 2 - DNA, 5589 bp, Artificial Sequence
  Synthetic
ggcctaactggccggtacctgagctcgctagcctcgaggatatcaagatctgccgccgcgatcgccatggcggtggaaggaggaatgaaatgtgtgaagttcttgctctacgtcctcctgctggccttttgcgcctgtgcagtgggactgattgccgtgggtgtcggggcacagcttgtcctgagtcagaccataatccagggggctacccctggctctctgttgccagtggtcatcatcgcagtgggtgtcttcctcttcctggtggcttttgtgggctgctgcggggcctgcaaggagaactattgtcttatgatcacgtttgccatctttctgtctcttatcatgttggtggaggtggccgcagccattgctggctatgtgtttagagataaggtgatgtcagagtttaataacaacttccggcagcagatggagaattacccgaaaaacaaccacactgcttcgatcctggacaggatgcaggcagattttaagtgctgtggggctgctaactacacagattgggagaaaatcccttccatgtcgaagaaccgagtccccgactcctgctgcattaatgttactgtgggctgtgggattaatttcaacgagaaggcgatccataaggagggctgtgtggagaagattgggggctggctgaggaaaaatgtgctggtggtagctgcagcagcccttggaattgcttttgtcgaggttttgggaattgtctttgcctgctgcctcgtgaagagtatcagaagtggctacgaggtgatgacgcgtacgcggccgctcgagatggagagcgacgagagcggcctgcccgccatggagatcgagtgccgcatcaccggcaccctgaacggcgtggagttcgagctggtgggcggcggagagggcacccccgagcagggccgcatgaccaacaagatgaagagcaccaaaggcgccctgaccttcagcccctacctgctgagccacgtgatgggctacggcttctaccacttcggcacctaccccagcggctacgagaaccccttcctgcacgccatcaacaacggcggctacaccaacacccgcatcgagaagtacgaggacggcggcgtgctgcacgtgagcttcagctaccgctacgaggccggccgcgtgatcggcgacttcaaggtgatgggcaccggcttccccgaggacagcgtgatcttcaccgacaagatcatccgcagcaacgccaccgtggagcacctgcaccccatgggcgataacgatctggatggcagcttcacccgcaccttcagcctgcgcgacggcggctactacagctccgtggtggacagccacatgcacttcaagagcgccatccaccccagcatcctgcagaacgggggccccatgttcgccttccgccgcgtggaggaggatcacagcaacaccgagctgggcatcgtggagtaccagcacgccttcaagaccccggatgcagatgccggtgaagaaagagttttctagagtcggggcggccggccgcttcgagcagacatgataagatacattgatgagtttggacaaaccacaactagaatgcagtgaaaaaaatgctttatttgtgaaatttgtgatgctattgctttatttgtaaccattataagctgcaataaacaagttaacaacaacaattgcattcattttatgtttcaggttcagggggaggtgtgggaggttttttaaagcaagtaaaacctctacaaatgtggtaaaatcgataaggatccgtttgcgtattgggcgctcttccgctgatctgcgcagcaccatggcctgaaataacctctgaaagaggaacttggttagctaccttctgaggcggaaagaaccagctgtggaatgtgtgtcagttagggtgtggaaagtccccaggctccccagcaggcagaagtatgcaaagcatgcatctcaattagtcagcaaccaggtgtggaaagtccccaggctccccagcaggcagaagtatgcaaagcatgcatctcaattagtcagcaaccatagtcccgcccctaactccgcccatcccgcccctaactccgcccagttccgcccattctccgccccatggctgactaattttttttatttatgcagaggccgaggccgcctctgcctctgagctattccagaagtagtgaggaggcttttttggaggcctaggcttttgcaaaaagctcgattcttctgacactagcgccaccatgaagaagcccgaactcaccgctaccagcgttgaaaaatttctcatcgagaagttcgacagtgtgagcgacctgatgcagttgtcggagggcgaagagagccgagccttcagcttcgatgtcggcggacgcggctatgtactgcgggtgaatagctgcgctgatggcttctacaaagaccgctacgtgtaccgccacttcgccagcgctgcactacccatccccgaagtgttggacatcggcgagttcagcgagagcctgacatactgcatcagtagacgcgcccaaggcgttactctccaagacctccccgaaacagagctgcctgctgtgttacagcctgtcgccgaagctatggatgctattgccgccgccgacctcagtcaaaccagcggcttcggcccattcgggccccaaggcatcggccagtacacaacctggcgggatttcatttgcgccattgctgatccccatgtctaccactggcagaccgtgatggacgacaccgtgtccgccagcgtagctcaagccctggacgaactgatgctgtgggccgaagactgtcccgaggtgcgccacctcgtccatgccgacttcggcagcaacaacgtcctgaccgacaacggccgcatcaccgccgtaatcgactggtccgaagctatgttcggggacagtcagtacgaggtggccaacatcttcttctggcggccctggctggcttgcatggagcagcagactcgctacttcgagcgccggcatcccgagctggccggcagccctcgtctgcgagcctacatgctgcgcatcggcctggatcagctctaccagagcctcgtggacggcaacttcgacgatgctgcctgggctcaaggccgctgcgatgccatcgtccgcagcggggccggcaccgtcggtcgcacacaaatcgctcgccggagcgcagccgtatggaccgacggctgcgtcgaggtgctggccgacagcggcaaccgccggcccagtacacgaccgcgcgctaaggaggtaggtcgagtttaaactctagaaccggtcatggccgcaataaaatatctttattttcattacatctgtgtgttggttttttgtgtgttcgaactagatgctgtcgaccgatgcccttgagagccttcaacccagtcagctccttccggtgggcgcggggcatgactatcgtcgccgcacttatgactgtcttctttatcatgcaactcgtaggacaggtgccggcagcgctcttccgcttcctcgctcactgactcgctgcgctcggtcgttcggctgcggcgagcggtatcagctcactcaaaggcggtaatacggttatccacagaatcaggggataacgcaggaaagaacatgtgagcaaaaggccagcaaaaggccaggaaccgtaaaaaggccgcgttgctggcgtttttccataggctccgcccccctgacgagcatcacaaaaatcgacgctcaagtcagaggtggcgaaacccgacaggactataaagataccaggcgtttccccctggaagctccctcgtgcgctctcctgttccgaccctgccgcttaccggatacctgtccgcctttctcccttcgggaagcgtggcgctttctcatagctcacgctgtaggtatctcagttcggtgtaggtcgttcgctccaagctgggctgtgtgcacgaaccccccgttcagcccgaccgctgcgccttatccggtaactatcgtcttgagtccaacccggtaagacacgacttatcgccactggcagcagccactggtaacaggattagcagagcgaggtatgtaggcggtgctacagagttcttgaagtggtggcctaactacggctacactagaagaacagtatttggtatctgcgctctgctgaagccagttaccttcggaaaaagagttggtagctcttgatccggcaaacaaaccaccgctggtagcggtggtttttttgtttgcaagcagcagattacgcgcagaaaaaaaggatctcaagaagatcctttgatcttttctacggggtctgacgctcagtggaacgaaaactcacgttaagggattttggtcatgagattatcaaaaaggatcttcacctagatccttttaaattaaaaatgaagttttaaatcaatctaaagtatatatgagtaaacttggtctgacagcggccgcaaatgctaaaccactgcagtggttaccagtgcttgatcagtgaggcaccgatctcagcgatctgcctatttcgttcgtccatagtggcctgactccccgtcgtgtagatcactacgattcgtgagggcttaccatcaggccccagcgcagcaatgatgccgcgagagccgcgttcaccggcccccgatttgtcagcaatgaaccagccagcagggagggccgagcgaagaagtggtcctgctactttgtccgcctccatccagtctatgagctgctgtcgtgatgctagagtaagaagttcgccagtgagtagtttccgaagagttgtggccattgctactggcatcgtggtatcacgctcgtcgttcggtatggcttcgttcaactctggttcccagcggtcaagccgggtcacatgatcacccatattatgaagaaatgcagtcagctccttagggcctccgatcgttgtcagaagtaagttggccgcggtgttgtcgctcatggtaatggcagcactacacaattctcttaccgtcatgccatccgtaagatgcttttccgtgaccggcgagtactcaaccaagtcgttttgtgagtagtgtatacggcgaccaagctgctcttgcccggcgtctatacgggacaacaccgcgccacatagcagtactttgaaagtgctcatcatcgggaatcgttcttcggggcggaaagactcaaggatcttgccgctattgagatccagttcgatatagcccactcttgcacccagttgatcttcagcatcttttactttcaccagcgtttcggggtgtgcaaaaacaggcaagcaaaatgccgcaaagaagggaatgagtgcgacacgaaaatgttggatgctcatactcgtcctttttcaatattattgaagcatttatcagggttactagtacgtctctcaaggataagtaagtaatattaaggtacgggaggtattggacaggccgcaataaaatatctttattttcattacatctgtgtgttggttttttgtgtgaatcgatagtactaacatacgctctccatcaaaacaaaacgaaacaaaacaaactagcaaaataggctgtccccagtgcaagtgcaggtgccagaacatttctct